(19) United States
(12) Patent Application Publication
(10) Pub. No.: US 2021/0387741 A1
(43) Pub. Date: Dec. 16, 2021

(54) SYSTEMS AND METHODS OF CONTROLLING ENGINES OF AN AIRCRAFT

(71) Applicant: ISRAEL AEROSPACE INDUSTRIES LTD., Lod (IL)

(72) Inventors: Alon TAMIR, Kfar Vradim (IL); Zvi GROS, Petach Tikva (IL)

(21) Appl. No.: 17/283,298

(22) PCT Filed: Sep. 26, 2019
(86) PCT No.: PCT/IL2019/051065

§ 371 Date: Apr. 7, 2021

(30) Foreign Application Priority Data
Oct. 14, 2018 (IL) 262426

(51) Int. Cl. B64D 31/10; B64D 31/04; G05D 1/08

(52) U.S. Cl. CPC B64D 31/10; B64D 2045/0085; G05D 1/0816; B64D 31/04

(57) ABSTRACT

There is provided a system for controlling at least first and second engines of an aircraft, comprising a common controlling unit configured to convert data representative of a thrust command transmitted by an actuating element controllable by a pilot or by an auto-throttle of the aircraft, into: (a) at least one first command usable by a controller of the first engine for controlling its operation based at least on said first command, and (b) at least one second command usable by a controller of the second engine for controlling its operation based at least on said second command, wherein said common controlling unit is operable to perform said conversion based at least on data representative of a level of operability of each engine, thereby making each engine to either comply with said thrust command or to operate differently from said thrust command, based at least on its level of operability.

### TECHNOLOGICAL FIELD

The invention is in the field of controlling an aircraft. In particular, the invention pertains, according to some embodiments, to control of engines of an aircraft.

### BACKGROUND

In a conventional multi-engine aircraft, a pilot controls a plurality of levers, wherein a position of each lever indicates a desired thrust (or power) for each one of the plurality of engines.

There is now a need to provide new systems and methods for controlling engines of a multi-engine aircraft.

### GENERAL DESCRIPTION

In accordance with certain aspects of the presently disclosed subject matter, there is provided a system for controlling a plurality of engines of an aircraft, wherein said plurality of engines comprises at least one first engine of the aircraft and at least one second engine of the aircraft, the system comprising a common controlling unit configured to convert data representative of a thrust command transmitted by an actuating element controllable by a pilot or by an auto-throttle of the aircraft, into:
(a) at least one first command usable by a controller of said at least one first engine for controlling operation of said at least one first engine based at least on said first command, and
(b) at least one second command usable by a controller of said at least one left engine for controlling operation of said at least one left engine based at least on said second command,
   wherein said common controlling unit is operable to perform said conversion based at least on data representative of a level of operability of each engine, thereby making each engine to either comply with said thrust command or to operate differently from said thrust command, based at least on its level of operability.

In addition to the above features, the system according to this aspect of the presently disclosed subject matter can optionally comprise one or more of features (i) to (x) below, in any technically possible combination or permutation:
i. the system comprises a single actuating element for controlling thrust of all engines of the aircraft, said actuating element being controllable by a pilot;
ii. the system comprises a single actuating element for controlling positive thrust of all engines of the aircraft, said actuating element being controllable by a pilot, and a single actuating element for controlling negative thrust of all engines of the aircraft, said actuating element being controllable by a pilot;
iii. said first command and said second command each substantially match said thrust command;
iv. the plurality of engines comprises engines P₁ to P_{N}, with N≥2, wherein, when the common controlling unit receives data representative of a failure of at least one engine Pⱼ of said plurality of engines, the common controlling unit is configured to generate a command usable by at least one controller, for controlling thrust of engines Pⱼ, with i from 1 to N being different from j, wherein said thrust is controlled in accordance with said data representative of a thrust command received by said common controlling unit.
v. the plurality of engines comprises engines P₁ to P_{N}, with N≥2, wherein when the system receives data representative of a failure of at least one engine Pⱼ of said plurality of engines, the common controlling unit is configured to instruct, by the common controlling unit, a controller of said engine Pⱼ to reduce thrust of engine Pⱼ at a first thrust value, wherein said first thrust value is lower than said thrust command provided by said actuating element or said auto-throttle;
vi. the system is configured to generate a command for controlling position of a yaw actuator of the aircraft, to compensate a yaw drift caused by said failure;
vii. the plurality of engines comprises engines P₁ to P_{N}, with N≥2, wherein the common controlling unit is configured to, upon receipt of a command instructing to turn on engine Pⱼ:
   instruct a controller of said engine Pⱼ to increase thrust of engine Pⱼ at a first thrust value, wherein said first thrust value differs from a thrust command provided by said actuating element or by said auto-throttle; and
   after a stabilization period, instruct said controller of said engine Pⱼ to set thrust of engine Pⱼ at a second thrust value which substantially matches said thrust command
viii. the system comprises for each engine, an interface comprising a security action position, which, upon activation, is configured to trigger a security action for handling a failure present in said engine, a start position, which, upon activation, is configured to start said engine, and a cut or emergency position, which, upon activation, turns off said engine, partially or totally;
ix. the system comprises an interface allowing inputting a command representative of a curvature of a trajectory of the aircraft on the ground;
x. upon input of a command through said interface, the common controlling unit is configured to generate at least one first command usable by a controller of at least one right engine for controlling thrust of said at least one right engine in compliance with said first command, and at least one thrust command usable by a controller of at least one left engine for controlling thrust of said at least one left engine in compliance with said second command,
   wherein thrust of said at least one right engine and thrust of said at least one left engine are selected to make the aircraft follow a curved trajectory which complies with said curvature.

According to another aspect of the presently disclosed subject matter there is provided a system for controlling a plurality of engines of an aircraft, wherein said plurality of engines comprises at least one right engine and at least one left engine, the system comprising an interface operable by a pilot to provide a command representative of a curvature of a trajectory of the aircraft on the ground, and a common controlling unit configured to generate at least one first command usable by at least one controller of said at least one right engine for controlling thrust of said at least one right engine based at least on said first command, and generate at least one second command usable by at least one controller of said at least one left engine for controlling thrust of said at least one left engine based at least on said at least one second command, wherein said first command and said second command are selected such that thrust of said at least one right engine and thrust of said at least one left engine allow the aircraft to follow a curved trajectory representative of said command provided on said interface.

In addition to the above features, the system according to this aspect of the presently disclosed subject matter can optionally comprise one or more of features (i) to (x) above, in any technically possible combination or permutation.

According to another aspect of the presently disclosed subject matter, there is provided a method of controlling a plurality of engines of an aircraft, wherein said plurality of engines comprises at least one first engine of the aircraft and at least one second engine of the aircraft, the method comprising:
obtaining data representative of a thrust command for said plurality of engines, transmitted by an actuating element controllable by a pilot or by an auto-throttle of the aircraft.
converting, by a common controlling unit, said data representative of said thrust command into:
   at least one first command usable by a controller of said at least one first engine for controlling operation of said at least one first engine based at least on said first command, and
   at least one second command usable by a controller of said at least one second engine for controlling operation of said at least one second engine based at least on said second command,

wherein said conversion is performed based at least on data representative of a level of operability of each engine, thereby making each engine to either comply with said thrust command or to operate differently from said thrust command, based at least on its level of operability.

In addition to the above features, the method according to this aspect of the presently disclosed subject matter can optionally comprise one or more of features (xi) to (xx) below, in any technically possible combination or permutation:
xi. a single actuating element controls thrust of all engines of the aircraft, said actuating element being controllable by a pilot;
xii. a single actuating element controls positive thrust of all engines of the aircraft, said actuating element being controllable by a pilot, and a single actuating element controls negative thrust of all engines of the aircraft, said actuating element being controllable by a pilot;
xiii. said first command and said second command each substantially match said thrust command;
xiv. the plurality of engines comprises engines P₁ to P_{N}, with N≥2, the method comprising receiving data representative of a failure at least one engine Pⱼ of said plurality of engines, generating a command usable by at least one controller, for controlling thrust of engines Pᵢ, with i from 1 to N being different from j, wherein said thrust is controlled in accordance with said data representative of a thrust command received by said common controlling unit;
xv. the plurality of engines comprises engines P₁ to P_{N}, with N≥2, the method comprising receiving data representative of a failure of at least one engine Pⱼ of said plurality of engines, instructing, by the common controlling unit, a controller of said engine Pⱼ to reduce thrust of engine Pⱼ at a first thrust value, wherein said first thrust value is lower than said thrust command provided by said actuating element or said auto-throttle;
xvi. the method comprises generating a command for controlling position of a yaw actuator of the aircraft, to compensate a yaw drift caused by said failure;
xvii. the plurality of engines comprises engines P₁ to P_{N}, with N≥2, the method comprising, upon receipt of a command instructing to turn on engine Pⱼ; instructing a controller of said engine Pⱼ to increase thrust of engine Pⱼ at a first thrust value, wherein said first thrust value differs from a thrust command provided by said actuating element or by said auto-throttle; and after a stabilization period, instructing said controller of said engine Pⱼ to set thrust of engine Pⱼ at a second thrust value which substantially matches said thrust command.
xviii. an interface controllable by the pilot comprises: a security action position, which, upon activation, triggers a security action for handling a failure present in said engine, a start position, which, upon activation, starts said engine, and a cut or emergency position, which, upon activation, turns off said engine, partially or totally;
xix. the method comprises receiving from an interface controllable by the pilot a command representative of a curvature of a trajectory of the aircraft on the ground; and
xx. upon input of a command through said interface, the method comprises generating at least one first command usable by a controller of at least one right engine for controlling thrust of said at least one right engine in compliance with said first command, and at least one thrust command usable by a controller of at least one left engine for controlling thrust of said at least one left engine in compliance with said second command, wherein thrust of said at least one right engine and thrust of said at least one left engine are selected to make the aircraft follow a curved trajectory which complies with said curvature.

According to another aspect of the presently disclosed subject matter there is provided a method of controlling a plurality of engines of an aircraft, wherein said plurality of engines comprises at least one right engine and at least one left engine, the method comprising:
obtaining a command representative of a curvature of a trajectory of the aircraft on the ground,
based on said command, generating, by a common controlling unit,
   at least one first command usable by at least one controller of said at least one right engine for controlling thrust of said at least one right engine based at least on said first command, and
   at least one second command usable by at least one controller of said at least one left engine for controlling thrust of said at least one left engine based at least on said at least one second command,

wherein said first command and said second command are selected such that thrust of said at least one right engine and thrust of said at least one left engine allow the aircraft to follow a curved trajectory representative of said command.

In addition to the above features, the method according to this aspect of the presently disclosed subject matter can optionally comprise one or more of features (xi) to (xx) above, in any technically possible combination or permutation:

According to another aspect of the presently disclosed subject matter there is provided a non-transitory storage device readable by a machine, tangibly embodying a program of instructions executable by the machine to perform a method controlling a plurality of engines of an aircraft, wherein said plurality of engines comprises at least one first engine of the aircraft and at least one second engine of the aircraft, the method comprising:
obtaining data representative of a thrust command for said plurality of engines, transmitted by an actuating element controllable by a pilot or by an auto-throttle of the aircraft,
converting, by a common controlling unit, said data representative of said thrust command into at least one first command usable by a controller of said at least one first engine for controlling operation of said at least one first engine based at least on said first command, and at least one second command usable by a controller of said at least one second engine for controlling operation of said at least one second engine based at least on said second command,

wherein said conversion is performed based at least on data representative of a level of operability of each engine, thereby making each engine to either comply with said thrust command or to operate differently from said thrust command, based at least on its level of operability.

In addition to the above features, the non-transitory storage device according to this aspect of the presently disclosed subject matter can optionally perform a method comprising one or more of features (xi) to (xx) above, in any technically possible combination or permutation.

According to another aspect of the presently disclosed subject matter there is provided a non-transitory storage device readable by a machine, tangibly embodying a program of instructions executable by the machine to perform a method of controlling a plurality of engines of an aircraft, wherein said plurality of engines comprises at least one right engine and at least one left engine, the method comprising:
obtaining a command representative of a curvature of a trajectory of the aircraft on the ground,
based on said command, generating, by a common controlling unit, at least one first command usable by at least one controller of said at least one right engine for controlling thrust of said at least one right engine based at least on said first command, and at least one second command usable by at least one controller of said at least one left engine for controlling thrust of said at least one left engine based at least on said at least one second command,

wherein said first command and said second command are selected such that thrust of said at least one right engine and thrust of said at least one left engine allow the aircraft to follow a curved trajectory representative of said command.

In addition to the above features, the non-transitory storage device according to this aspect of the presently disclosed subject matter can optionally perform a method comprising one or more of features (xi) to (xx) above, in any technically possible combination or permutation.

According to some embodiments, the proposed solution improves efficiency and quality of control of engines of an aircraft.

According to some embodiments, the proposed solution provides simplification of control of an aircraft for a pilot. As a consequence, pilot's fatigue is reduced.

According to some embodiments, the proposed solution provides a better and safer handling of aircraft flight incidents, such as fire in engines, failure of engines, etc.

According to some embodiments, the proposed solution reduces the complexity of the intervention expected from a pilot during flight incidents.

According to some embodiments, the proposed solution increases automation of handling flight incidents which involve malfunction of one or more engines.

According to some embodiments, the proposed solution improves safety of flights.

According to some embodiments, the proposed solution improves control of aircraft whilst on the ground.

According to some embodiments, the proposed solution improves safety of aircraft during ground operations.

According to some embodiments, the proposed solution facilitates starting engines of the aircraft whilst on the ground.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates an embodiment of a system for controlling a plurality of engines of an aircraft;

FIG. 1A illustrates an embodiment of a single lever for controlling thrust of all engines of the aircraft;

FIG. 1B illustrates an embodiment of a lever comprising a rotating element for inputting a command representative of a curvature of the trajectory of the aircraft;

FIG. 1C illustrates an embodiment of an interface comprising different positions allowing handling normal and malfunction of an engine, such as a fire;

FIG. 2 illustrates a method of controlling engines of an aircraft using e.g. the system of FIG. 1;

FIG. 3 describes another embodiment of a method for controlling engines of the aircraft, wherein one engine encounters a malfunction;

FIG. 4 describes an operation in which a yaw drift due to asymmetric propulsion is reduced;

FIG. 4A describes another embodiment of a method for controlling engines of an aircraft, wherein one engine encounters a malfunction;

FIG. 4B describes an embodiment of a method of starting one or more engines of the aircraft;

FIG. 5 describes an embodiment of a method for controlling a curvature of a trajectory of the aircraft whilst on the ground;

FIG. 6 describes an example of a rotation of a rotating member of a lever of the aircraft; and

FIG. 7 describes an embodiment of a method for controlling engines of an aircraft when at least one engine encounters a malfunction such as a fire.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

Unless specifically stated otherwise, as apparent from the following discussions, it is appreciated that throughout the specification discussions utilizing terms such as “generating”, “converting”, “determining”, “instructing”, or the like, refer to the action(s) and/or process(es) of a processing unit that manipulates and/or transforms data into other data, said data represented as physical, such as electronic, quantities and/or said data representing the physical objects.

The term “processing unit” as disclosed herein should be broadly construed to include any kind of electronic device with data processing circuitry, which includes for example a computer processing device operatively connected to a computer memory (e.g. digital signal processor (DSP), a microcontroller, a field programmable gate array (FPGA), and an application specific integrated circuit (ASIC), etc.) capable of executing various data processing operations.

It can encompass a single processor or multiple processors, which may be located in the same geographical zone or may, at least partially, be located in different zones and may be able to communicate together.

The term “memory” as used herein should be expansively construed to cover any volatile or non-volatile computer memory suitable to the presently disclosed subject matter.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

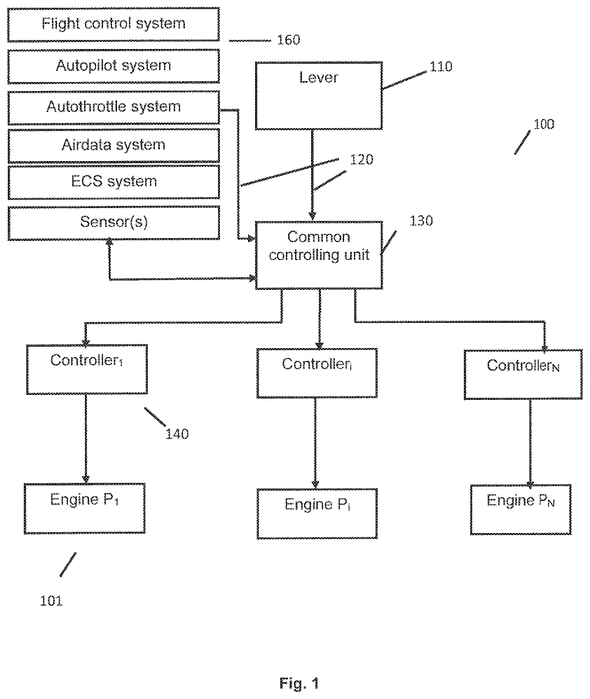

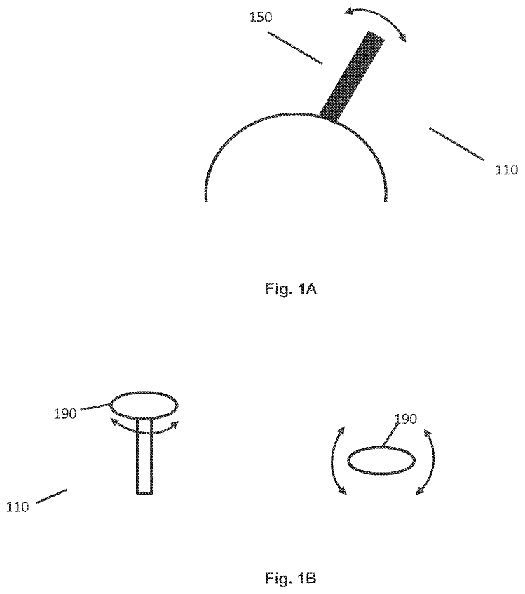

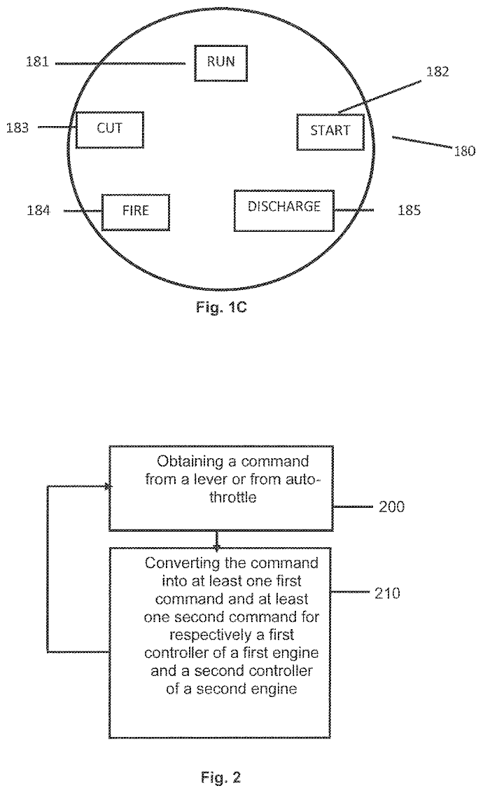

Attention is drawn to FIG. 1.

FIG. 1 depicts an embodiment of a system 100 for controlling a plurality of engines of an aircraft.

An engine can comprise e.g. a propeller, a turbo-propeller, a turbo-fan, a variable pitch propeller, an electrical engine, etc. This list is not limitative.

As shown, the aircraft comprises a plurality of engines 101 Pᵢ, with i from 1 to N and N≥2.

According to some embodiments, the aircraft comprises at least one right engine (or a plurality of right engines) and at least one left engine (or a plurality of left engines). Right side and left side are generally defined with respect to a main axis of a body of the aircraft. This is not limitative and according to some embodiments, at least some of (or all) the engines are located on the axis of the body of the aircraft, or in the vicinity of this axis, or in any adapted location.

System 100 can comprise (or can be operatively connected to) an actuating element, such as a throttle or lever 110 controllable in particular by a pilot of the aircraft. In the following, it will be referred to a lever, but this is not limitative and other kinds of actuating elements controllable by a pilot can be used (different examples will be provided).

Depending on commands provided by the pilot on this lever 110, and/or by thrust commands provided by an auto-throttle and/or auto-pilot of the aircraft, thrust of the plurality of engines can be controlled. In other words, the pilot indicates, using this lever 110, a level of thrust desired for the engines of the aircraft.

Therefore, based on commands provided e.g. by the pilot, data representative of a thrust command is generated by the lever 110. It has to be noted that data representative of a thrust command are also representative of a power command, since thrust and power of an engine are directly correlated.

Similarly, the auto-throttle can generate data representative of a thrust command based e.g. on inputs of a pilot (e.g. the pilot sets a desired speed, or thrust, if necessary with some additional parameters such as altitude, and the auto-throttle generates data representative of a thrust command which corresponds to the pilot's input). In some embodiments, the auto-throttle can modify a physical position of the lever 110 in accordance with the thrust command.

According to some embodiments, lever 110 can control the thrust of all engines of the aircraft.

According to some embodiments, the system comprises a single lever 110 for controlling the positive thrust of all engines of the aircraft. In other words, the pilot provides a single thrust command (using this single lever) and controls positive thrust of all engines of the aircraft.

According to some embodiments, the system comprises a single lever 110 for controlling the positive thrust and the negative thrust of all engines of the aircraft. In other words, the pilot provides a single positive or negative thrust command (using this single lever) and controls positive or negative thrust of all engines of the aircraft. For example, when the pilot moves forward the lever, this will create a positive thrust command, and when the pilot moves backwards the lever, this will create a negative thrust command. This is however not limitative.

According to some embodiments, the system comprises a single lever 110 for controlling the positive thrust of all engines of the aircraft. In addition, a single sub-component of this single lever 110 (this can be e.g. a moving element present on the lever 110, or when a negative thrust has to be created on ground, this can correspond to element 150 described hereinafter) can be used for controlling the negative thrust of all engines of the aircraft.

In other words, the pilot can provide a single positive thrust command using single lever 110 which controls positive thrust of all engines of the aircraft, and the pilot can provide a single negative thrust command using the above-mentioned sub-component which controls negative thrust of all engines of the aircraft.

According to some embodiments, the system comprises a single lever 110 for controlling the positive thrust of all engines of the aircraft, and another single lever (which can be distinct from the first lever) for controlling the negative thrust of all engines of the aircraft. In other words, the pilot can provide a single positive thrust command using a first single lever which controls positive thrust of all engines of the aircraft, and the pilot can provide a single negative thrust command using a second single lever which controls negative thrust of all engines of the aircraft.

According to some embodiments, data representative of a single thrust command is generated by the lever (or by a processing unit connected to the lever and suitable for translating the position of the lever into a thrust command), and based on this single thrust command, the thrust of all engines can be controlled.

According to some embodiments, and as shown in FIG. 1A, a single movable element 150 of the lever 110 indicates the thrust desired by the pilot for the engines.

In other words, it is possible to control the thrust of the plurality of engines of the aircraft (in particular of all engines of the aircraft) with a single movable element 150.

As already mentioned above, a lever is only a possible example of an actuating element which can be present in the aircraft for providing a thrust command. Other examples include a joystick, a graphical interface, a keyboard, an electronic button, an interface controllable by voice (etc.) with which the pilot can indicate a thrust level for the engines—in particular, according to some embodiments, a single thrust level can be indicated for all engines by the pilot using this actuating element (in some embodiments, a single actuating element controls positive and negative thrust of all engines, and in other embodiments, a single first actuating element controls positive thrust of all engines and a single second actuating element controls negative thrust of all engines).

As shown in FIG. 1, a common controlling unit 130 of system 100 receives data representative of a thrust command 120 from the lever 110 and/or from the auto-throttle system of the aircraft.

The common controlling unit 130 is operable on a processing unit and can comprise in some embodiments data circuitry and a memory. In some embodiments, the common controlling unit 130 can include an embedded system (or unit) with one or more lanes. It can include an analog or digital input/output (I/O) interface. According to some embodiments, the common controlling unit 130 comprises complex hardware (e.g. FPGA, ASIC) or computer hardware (e.g. CPU, RAM, ROM).

As explained hereinafter in the specification, the common controlling unit 130 can receive other commands from the pilot and/or the auto-pilot of the aircraft, such as a command representative of a curvature of the trajectory of the aircraft on ground.

As shown in FIG. 1, the common controlling unit 130 can generate a plurality of commands, based at least on commands it receives from the lever 110 and/or the auto-throttle of the aircraft.

In particular, the common controlling unit 130 can generate, based on data representative of a thrust command:
at least one first command usable by a controller 140 of at least one first engine for controlling operation of said at least one first engine based at least on said first command; and
at least one second command usable by a controller 140 of at least one second engine for controlling operation of said at least one second engine based at least on said second command.

For example, assume the aircraft comprises a right engine P1, controlled by a controller C1 and a left engine P2 controller by a controller C2.

The common controlling unit 130 can receive data representative of a thrust command from the lever 110 and can generate a first command for the controller C1 and a second command for the controller C2.

As explained hereinafter in the specification, the first command and the second command are generally also each representative of a thrust command.

The controller 140 of an engine is for example a FADEC (Full Authority Digital Engine), an “electronic engine controller” (EEC) or an “engine control unit” (ECU). This is however not limitative. A FADEC generally receives a position of the lever which represents a thrust level.

According to some embodiments, a single common controlling unit 130 can generate commands for all controllers of all engines of the aircraft.

According to some embodiments, the controller 140 (e.g. FADEC) converts a command received from the common controlling unit 130 into at least one command pertaining to engine operating parameters such as fuel flow, stator vane position, air bleed valve position, rotation speed of the fan, etc. In other words, the controller 140 can translate data representative of a thrust command received from the common controlling unit 130 into a command for the engine which ensures that the engine complies with the thrust command.

According to some embodiments, the controller 140 of an engine also controls and monitors engine starting and relighting.

According to some embodiments, the first command and the second command can be thrust commands generated by the common controlling unit 130 (based on the thrust command provided by the lever 110 or the auto-throttle).

The first command is transmitted to a first controller which converts it into a command pertaining to engine operating parameters for a first engine. The conversion can depend on various parameters, such as operability of the engines, parameters of the flight, etc.

Engine operating parameters of the first engine are selected such that resulting thrust/power of the first engine controlled by said first controller matches the first command (which is e.g. a thrust command). For example, appropriate rotation speed of the turbine, angle of attack of the blades, etc. are selected to match the thrust command (first command).

Similarly, the second command is transmitted to a second controller which converts it into a command pertaining to engine operating parameters for a second engine.

Engine operating parameters of the second engine are selected such that thrust/power of the second engine controlled by said second controller matches the second command (which is e.g. a thrust command).

According to some embodiments, a given controller can comprise multi-channels, in order to control multiple engines. In this case, each channel is dedicated to control engine operating parameters of a different engine. For example, a given controller can be assigned to control engine operating parameters of a plurality of engines located on the right side of the aircraft. In this case, the given controller will apply the command generated by the common controlling unit to the plurality of engines that it controls. This is however not limitative.

According to some embodiments, the common controlling unit 130 can communicate with various other systems 160 and exchange data with them. These systems 160 include at least one of:
sensors of the aircraft (such as altitude sensor, pressure sensor, temperature sensor, fire detector, all engine parameters, etc.);
flight control system of the aircraft (data such as data representative of flight phase, commands transmitted to flight actuators, etc. can be exchanged);
autopilot system of the aircraft (data generated by the autopilot system can be exchanged);
auto throttle system of the aircraft (data such as target speed, target thrust, etc., can be exchanged);
air data system of the aircraft, and/or Air Data Inertial Reference Unit (data such as calibrated airspeed, Mach number, altitude, and altitude trend data, etc., can be exchanged);
environmental control system (ECS) of the aircraft (data representative of e.g. air supply, thermal control and cabin pressurization for the crew and passengers, avionics cooling, smoke detection, etc., can be exchanged); and
de-icing systems of the aircraft (e.g. of body, wing and engine nacelle) can also exchange data with the system.

The common controlling unit 130 can generate commands for the controllers 140 of the engines 101 based also on one or more of the data received from one or more of the systems 160 mentioned above. Various examples will be provided hereinafter.

According to some embodiments, the common controlling unit 130 stores in at least one memory one or more predefined operations to be applied for each of a plurality of predefined flight/ground scenarios (e.g. malfunction/failure of an engine, etc.). For each scenario, the common controlling unit 130 can execute these instructions in order to appropriately convert the commands communicated by the pilot via the lever 110, or transmitted by the auto-throttle, into commands to be sent to the controllers 140 of the engines 101.

According to some embodiments, the lever 110 comprises a rotating member. Therefore, a pilot of the aircraft can rotate this rotating member to control motion of the aircraft. As explained hereinafter in the specification, this rotating member can be used to control, in an efficient way, the aircraft on the ground along a non-linear trajectory, such as a curved trajectory, based on the rotation of this rotating member.

A non-limitative example is illustrated in FIG. 1B. The lever 110 comprises a rotating member 190. The rotating member 190 comprises e.g. a knob, a wheel, etc.

This rotating member 190 can be rotated around an axis parallel to the main axis of the lever 110. A command representative of the rotation of the rotating member 190 can be generated by the lever 110 and transmitted to the common controlling unit 130.

This example is not limitative and other configurations can be used for the rotating member.

In some embodiments, the pilot can provide a command representative of a curvature of the trajectory of the aircraft using another interface (such as a screen, a joystick, a voice command, etc.).

Attention is now drawn to FIG. 1C.

According to some embodiments, system 100 can comprise, or can be connected to an additional interface 180. This additional interface 180 can comprise:
a run position 181, indicating that the engine is running;
a start position 182, for starting the engine;
a cut position 183, for cutting off the engine, at least partially (this position is generally used for “normal” shutdown of an engine);
a fire (or more generally “emergency”) position 184, usable for cutting off additional elements of the engine or in communication with the engine (this position can trigger an “emergency” shutdown of the engine); and
a discharge position 185, for triggering a security action.

According to some embodiments, the additional interface 180 can rotate. Depending on the angular position of the additional interface 180, the corresponding action is activated (for example, when the interface 180 is rotated so that a predefined indicator of the interface is located at the “start” position 182, the engine is started).

According to some embodiments, for each engine, there is such an additional interface 180. Embodiments of methods which rely on this additional interface 180 will be described hereinafter.

Attention is now drawn to FIG. 2, which describes a method of controlling engines of an aircraft using e.g. the system of FIG. 1.

The method can comprise (operation 200) obtaining a command from an actuating element controllable by a pilot, such as lever 110, or from the auto-throttle system of the aircraft. This command transmitted by the lever can be generated e.g. by the lever, or a by a processing unit in communication with the lever, based e.g. on a level of displacement of the lever by the pilot.

This command can be transmitted to the common controlling unit 130.

This command can be representative of a thrust level desired by the pilot or auto-throttle for the engines 101.

As mentioned, in some embodiments, a single thrust command is obtained based on a single input of the pilot, for all engines. The same can apply to the command of the auto-throttle, which can be a single thrust command for all engines of the aircraft.

The method can comprise converting (operation 210), by the common controlling unit 130, the received command into at least one first command and at least one second command. As explained hereinafter in the specification, the common controlling unit 130 can take into account various data in order to perform this conversion, such as:
data representative of the state of the engines (e.g. normal operation, underperforming, partial failure, total failure, etc.);
data representative of the flight conditions (altitude, temperature, pressure, speed, etc.);
data representative of e.g. air supply, thermal control and cabin pressurization for the crew and passengers, avionics cooling, smoke detection, etc.;
data sent by the autopilot system; and
data sent by the auto throttle system, etc.

Assume the aircraft has two engines (right engine and left engine), or more. The first command can be computed so as to be received by a first controller 140 (e.g. FADEC) of the right engine, and the second command can be computed so as to be received by a second controller 140 (e.g. FADEC) of the left engine.

The first command can be e.g. a command representative of a thrust required for the right engine. Similarly, the second command can be e.g. a command representative of a thrust required for the left engine.

This can be applied for more than two engines. Depending on the number N of controllers 140 for this plurality of N′ engines 101 (with N>2, N′>2), more than two commands can be generated for the controllers of these engines. Generally. N=N′ and therefore the common controlling unit 130 generates N=N′ commands. This is however not mandatory, and in some embodiments, N<N′, and therefore the common controlling unit can generate N commands for N controllers controlling N′ engines.

According to some embodiments, the first command and the second command are equal and substantially correspond to the thrust command provided by the lever 110 or the auto-throttle.

According to some embodiments, the first command and the second command can be different. Examples will be provided hereinafter, in which an asymmetric thrust is set for the engines 101, although the pilot or the auto-throttle may have only provided a single thrust command for all engines.

According to some embodiments, the first command and/or the second command can be different from the command generated by the lever 110 based on the pilot input, or from the auto-throttle command. Examples will be provided hereinafter, in which the common controlling unit 130 generates a first and/or second command which is new and differs from the command 120 based on other data that it receives, such as level of operability of an engine, status of the aircraft, etc.

As already explained with respect to FIG. 1, the controller 140 of each engine 101 can control the corresponding engine 101 based on the command it has received from the common controlling unit 130.

Engine operating parameters such as fuel flow, stator vane position, air bleed valve position, rotation speed of the turbine, etc. can be controlled by the controller of each engine to reflect the thrust command it has received from the common controlling unit 130.

During operation of the aircraft (e.g. on the ground and/or in flight) operations 200 and 210 can be repeated, depending e.g. on the actions of the pilot on the actuator of the system, on flight conditions, on possible malfunction of the engines, etc.

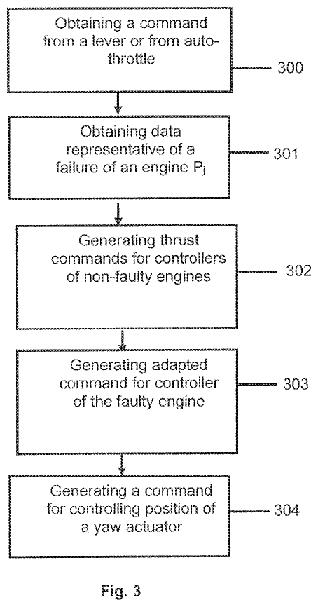

Attention is now drawn to FIG. 3, which describes another embodiment of a method of controlling engines of the aircraft.

Operations depicted in FIG. 3 are not necessarily performed in the order in which they are depicted. In addition, at least some of operations depicted in FIG. 3 can be performed in parallel.

Assume the aircraft comprises engines P₁ to P_{N}, with N≥2.

The method can comprise obtaining (operation 300) a command (data representative of a thrust command) from lever 110 controllable by a pilot, or from an auto-throttle. Operation 300 is similar to operation 200 above. This command can be transmitted to the common controlling unit 130. In particular, a single thrust command can be transmitted to the common controlling unit 130 based on the pilot's input on lever 110, or based on the instructions of the auto-throttle.

The method can comprise obtaining (operation 301), by the common controlling unit 130, data representative of a malfunction and/or failure of at least one engine Pⱼ (with j a value between 1 and N). This data can be transmitted e.g. by the controller of the faulty engine Pⱼ, or by at least one sensor of the aircraft, or by a central processing unit of the aircraft, or by any other adapted system.

According to some embodiments, malfunction/failure of an engine can be classified into at least three categories:
underperforming of the engine;
partial failure of the engine;
total failure of the engine.

Other classifications can be used.

As mentioned above, in the presented situation, the pilot provides a single thrust command (using the lever 110) while at least one engine is faulty. The same can apply to the auto-throttle, which can send a common thrust command for all engines.

According to some embodiments, the common controlling unit 130 can generate command(s) usable by the respective controller(s) 140 of each engine Pᵢ, with i from 1 to N being different from j.

In other words, the thrust command transmitted by the lever 110 or by the auto-throttle is converted into corresponding thrust commands for only the controllers 140 which control the non-faulty engines Pᵢ (i different from j).

According to some embodiments, assume the thrust command generated received by the common controlling unit 130 is equal to X, then the common controlling unit 130 can generate a thrust command substantially equal to X for only each of the controllers of the non-faulty engines. As a consequence, the non-faulty engines will have thrust which is substantially equal to the thrust command inputted by the pilot or sent by the auto-throttle.

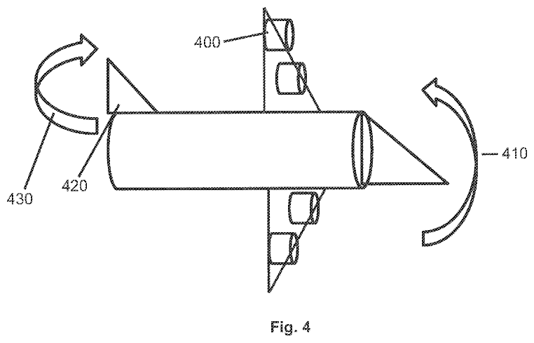

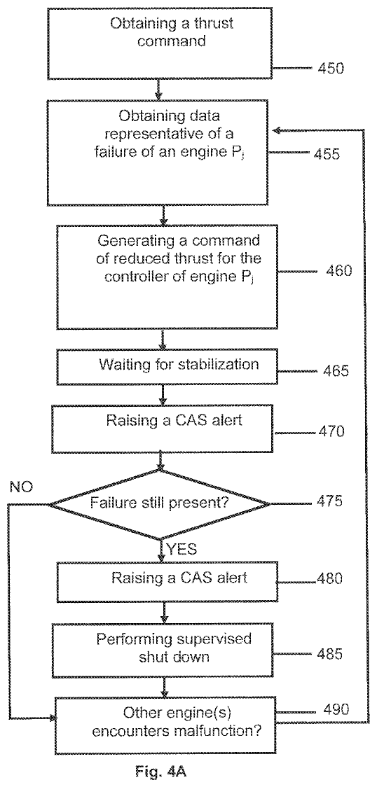

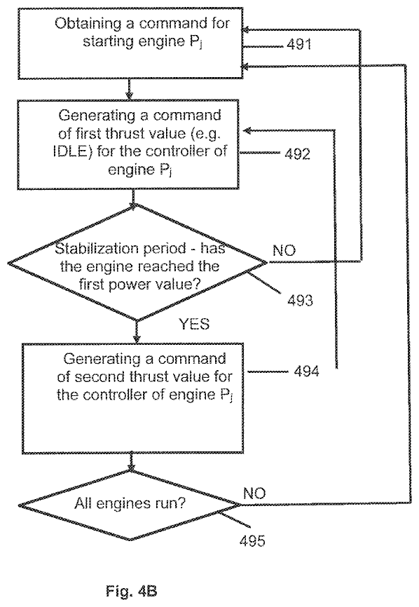

Concerning the faulty engine Pⱼ, the common controlling unit 130 can generate (see operation 303) a thrust command to the controller of engine Pⱼ to instruct it e.g. to set a thrust of engine Pⱼ at a reduced level (which is lower than the thrust level requested by the pilot using the lever, or requested by the auto-throttle). A possible embodiment of such control will be described with reference to FIG. 4A.

Therefore, although the pilot (or the auto-throttle) may provide a single thrust command, the common controlling unit 130 generates different thrust commands for the respective controllers of the engines, depending on the operability of the respective engines.

As shown in FIG. 4, when at least one engine is faulty (see engine 400), an asymmetric propulsion can be present in the aircraft, thereby generating a yaw drift (see arrow 410).

According to some embodiments, an auto-pilot system of the aircraft can generate a yaw command for controlling position of a yaw actuator 420 of the aircraft, to compensate for the yaw drift caused by this failure.

According to some embodiments, the common controlling unit 130 (or another system of the aircraft, such as the auto-pilot) can generate (operation 304) a yaw command for controlling position of a yaw actuator 420 of the aircraft, to compensate for the yaw drift caused by this failure. The yaw actuator 420 is for example a rudder of the aircraft, as depicted in FIG. 4.

Yaw drift 410 is compensated for by displacement 430 of yaw actuator 420.

According to some embodiments, the yaw command is computed, such as yaw drift is zero or below a threshold (which can be static, or dynamic).

According to some embodiments, a filter, such as a Kalman filter, present in the common controlling unit 130 can be used to determine the yaw command. The filter can receive data representative of the current yaw of the aircraft, data representative of the failure of the engine, and other flight data, in order to generate an appropriate yaw command.

According to some embodiments, the common controlling unit 130 can reduce the yaw drift by determining appropriate thrust commands for the non-faulty engines which compensate for this drift.

Assume the aircraft comprises N/2 right engines and N/2 left engines.

Assume one right engine is faulty. As a consequence, the propulsion provided by the left engines is higher than the propulsion provided by the right engines, thereby creating a yaw drift.

Assume the pilot (or the auto-throttle) has provided a thrust command which has a value of Y for the engines. The common controlling unit 130 can generate a thrust command equal to Y for the controllers of the right engines which are not faulty, and a thrust command equal to Y′, with Y′<Y, for the controllers of the left engines which are not faulty, in order to reduce the asymmetric propulsion. Value of Y′ is limited to the minimum thrust needed for the aircraft to fly in a safe manner.

This control can be performed in conjunction with the yaw command provided by the common controlling unit 130, or independently from it.

With the method of FIG. 4, the pilot can control the aircraft in a simpler way, since he does not need to take into account in his commands the fact that an engine is faulty and creates asymmetric propulsion. The common controlling unit 130 handles consequences of this failure independently. Safety of the flight is thus increased.

Attention is now drawn to FIG. 4A which describes an embodiment of a method of controlling engines of an aircraft, when at least one engine encounters malfunction and/or failure during flight of the aircraft.

Operations depicted in FIG. 4A are not necessarily performed in the order in which they are depicted. In addition, at least some of operations depicted in FIG. 4A can be performed in parallel.

Operation 450 comprises obtaining a command (such as a thrust or power command) from an actuating element (such as lever 110) controllable by a pilot, or from an auto-throttle of the aircraft. Operation 450 is similar to operation 300 of FIG. 3 and is not described again.

Operation 455 comprises obtaining data representative of a failure of at least one engine Pⱼ. When this data do not meet a safety threshold, this indicates that the failure exceeds a predetermined level, which requires taking a safety action.

For example, data representative of the fact that a temperature of the engine does not meet a safety threshold can be received (e.g. temperature can be higher than acceptable temperature, or can be lower than operating temperatures, etc.), thereby indicating that a failure is present in the engine.

In some embodiments, an alert can be received from the controller of the engine indicating that operating parameters of the engine do not meet a safety threshold and therefore are indicative of a possible failure of the engine.

Operation 460 can comprise generating by the common controlling unit 130 a thrust command for the controller of the faulty engine Pⱼ which is different from the thrust command inputted by the pilot or by the auto-throttle at operation 450.

In particular, the common controlling unit 130 can instruct a controller of the faulty engine to reduce thrust of the faulty engine Pⱼ at a value which is lower than the thrust command provided by the pilot or the auto-throttle.

According to some embodiments, the common controlling unit 130 can instruct a controller of the faulty engine Pⱼ to set the faulty engine Pⱼ in an “IDLE” state, in which the thrust is reduced, but in which the engine Pⱼ is not yet shutdown.

This can be performed in order to avoid further deterioration of the engine's functioning, which could result in serious damage to the engine and/or to the aircraft.

According to some embodiments, operation 460 can be performed automatically by the common controlling unit 130, with, or without requiring intervention of the pilot.

Once the thrust of the faulty engine Pⱼ is set at a reduced value, according to some embodiments, the method can comprise a waiting during a certain waiting period, such that thrust of the faulty engine Pⱼ stabilizes at this value (operation 465).

According to some embodiments, the method can comprise (operation 470) raising an alert for the pilot (such as a “Cres-Alerting system” alert—CAS alert). This alert can be raised e.g. to indicate to the pilot that one of the engines has encountered a failure.

Indeed, as mentioned above, operations 455, 460 and 465 can be in some embodiments performed without intervention of the pilot, and therefore the pilot needs to receive an alert that an engine is faulty (and that the thrust of this engine has been set at a reduced level), so that he is made aware of the situation.

According to some embodiments, the common controlling unit 130 can trigger such an alert, by sending a command to an alerting system (e.g. a display, a sound speaker, etc.) of the aircraft to raise a visual and/or audio alert. In other embodiments, another processing unit of the aircraft can trigger this alert, by sending a command to an alerting system of the aircraft to raise a visual and/or audio alert.

At this stage, if the pilot or the auto-throttle modifies the desired thrust for the engines, the common controlling unit 130 generates a corresponding command to the respective controllers of the non-faulty engines in order to obtain the thrust desired by the pilot or the auto-throttle, and sends a command to the controller of the faulty engine in order to maintain a reduced value for the thrust of this faulty engine.

At operation 475, it can be checked whether failure of engine Pⱼ is still present. This verification can be performed e.g. after a certain waiting period, once thrust of the engine Pⱼ has stabilized at its reduced value.

According to some embodiments, this verification can be performed e.g. by checking if an alert indicative of a failure of the engine Pⱼ is still present.

According to some embodiments, this verification can be performed by checking if data representative of the engine Pⱼ still do not match a safety threshold.

If it is apparent that the failure has ceased, the method can comprise maintaining the engine at its reduced thrust value. Indeed, even if it is apparent that the failure has ceased, it cannot be assumed that the engine has returned to an operational state, and overcoming of the failure could be due to the fact that the thrust of the engine has been reduced. Therefore, for security reasons, thrust of the engine is maintained at a reduced value.

The method can further comprise operation 490, in which it can be determined whether another engine has encountered a failure which requires taking safety actions. At least some of operations 460 to 485 can be repeated for this other engine. This process can be repeated several times, for each engine which is detected as faulty.

If the failure is still present, the method can comprise (operation 480) raising a second alert (such as a “Crew-Alerting system” alert—CAS alert) to the pilot. This alert can be indicative of the fact that the failure of engine Pⱼ is still present.

According to some embodiments, the common controlling unit 130 can trigger this second alert, by sending a command to an alerting system of the aircraft for raising a visual and/or audio alert. In other embodiments, another processing unit of the aircraft can trigger this second alert, by sending a command to an alerting system of the aircraft for raising a visual and/or audio alert.

The method can comprise (operation 485) performing a supervised shut-down of the faulty engine Pⱼ. Indeed, since the failure is still present, this can indicate that there is a risk that the engine may explode, cause internal damage to the engine, or cause damage to the aircraft. For safety reasons, it can be decided to shut down the engine, as explained hereinafter.

In operation 485, upon instructions of the pilot, the faulty engine Pⱼ is shut down. According to some embodiments, the pilot can activate a shut-down interface of the faulty engine Pⱼ (such as a shut-down button specific to this engine) which sends a command to the controller of the engine for shutting down the engine. For example, the pilot can activate the “cut” position 183 present in the additional interface 180.

According to some embodiments, a shut-down instruction of the engine is provided by the pilot and transmitted to the common controlling unit 130 which transfers this command to the controller of the faulty engine Pⱼ.

According to some embodiments, in order to avoid that the pilot inputs a shut-down instruction of an engine which is not faulty, the method can comprise verifying (e.g. by the common controlling unit 130) that the shut-down instruction of an engine matches with the engine which is faulty. If there is a match, the method can comprise transferring the shut-down instruction (e.g. by the common controlling unit 130), and if there is not a match, the method can comprise providing feedback to the pilot that his instruction does not comply with the current state of the engine, and ignoring the shut-down instruction of the pilot.

The method can further comprise operation 490, in which it can be checked whether another engine has encountered a failure which requires taking safety actions. At least some of operations 460 to 485 can be repeated for this other engine. This process can be repeated several times, for each engine which is detected as faulty.

According to some embodiments, if at least one engine is detected as faulty and therefore its thrust is reduced (or in some cases its thrust is set to zero), an operation can be performed to avoid a yaw drift of the aircraft due to its asymmetric propulsion, as explained with respect to operation 304 in FIG. 3.

Attention is now drawn to FIG. 4B.

When the aircraft is on the ground, e.g. before take-off, the pilot generally needs to start each of the engines of the aircraft. In conventional aircraft, this process is performed by starting a first engine, setting its thrust to an IDLE state, and then to a higher thrust which is adapted to take-off. These operations are repeated for each engine, until all engines are operating at a thrust which is sufficient for take-off.

FIG. 4B describes a method of starting engines using the system of FIG. 1.

According to some embodiments, the method can comprise operation 491, in which a command is obtained which represents an instruction that engine Pⱼ has to be switched on. This command can be generated following an instruction of the pilot using an interface such as a switching button present in the aircraft and associated to this engine Pⱼ. For example, the “start” position 182 of the additional interface 180 can be activated.

This command can be obtained e.g. by the common controlling unit 130.

As mentioned above, according to some embodiments (see e.g. FIG. 1), a single lever commands thrust/power of all engines. Therefore, it may occur that the lever is currently providing a thrust command whose level is adapted e.g. for taxi or take-off (if permitted for certain aircraft to take off without all engines running), and not for starting the engine. As mentioned above, an engine is generally switched on gradually, first at a thrust/power corresponding e.g. to an IDLE mode, and then at a higher thrust.

At operation 492, following the instructions of the pilot to start engine Pⱼ, the common controlling unit 130 can generate a command for the controller of engine Pⱼ in order to increase thrust of the engine Pⱼ at a first thrust value (e.g. this can correspond to an IDLE mode).

In some embodiments, this first thrust value can be different from the thrust command provided by the lever. In particular, in some embodiments, the first thrust value can be lower than the thrust command provided by the lever.

This can be due to the fact that the pilot has already switched on another engine in preparation for take-off, and therefore had to increase, using the lever, thrust of this engine to a higher value than that of IDLE mode. In other words, although the single lever may have provided a thrust command which is not adapted for starting engine Pⱼ, the common controlling unit generates a different thrust command for the controller of engine Pⱼ, which is adapted for starting gradually engine Pⱼ.

After a stabilization period (see 493), the method can comprise verifying if the engine has managed to reach the first thrust value. If this is the case, the method can comprise moving to operation 494. If the engine did not manage to reach the first thrust value (e.g. because the engine is faulty), the method can comprise reverting back to operation 491, in which an instruction to start another engine can be obtained.

In operation 494, the common controlling unit 130 can instruct the controller of engine Pⱼ to set thrust of engine Pⱼ at a second thrust value which corresponds substantially to the thrust command of the lever. In other words, after the engine has been switched on and has stabilized at a first reduced thrust, the thrust of the engine is then increased to match with the thrust command provided by the actuator.

If all (non-faulty) engines run and have a thrust which matches with the thrust command provided by the lever, the method can stop operating. If at least one (non-faulty) engine has not yet been switched on, the method can revert back to operation 491, in order to repeat the process for another engine Pₖ, with k being different from j. Operations which follow operation 491 can be repeated similarly for engine P_{L}.

These operations can be repeated until all (non-faulty) engines run and have a thrust which corresponds to the thrust command of the actuator.

In the embodiments above, examples have been described in which the common controlling unit 130 can generate a different thrust command than the one received from the pilot or auto-throttle. In some embodiments, the common controlling unit 130 can generate a thrust command which is higher than the thrust command provided by the single lever or by the auto-throttle. For example, the pilot can provide a reduced thrust command X during take-off of the aircraft (e.g. for reducing consumption of the engine, wherein X is less than the maximal thrust of the engine), and the common controlling unit 130 will generate a higher thrust command X′>X (for example if the engine is detected as faulty, and therefore, a higher thrust command should be provided to compensate for this malfunction).

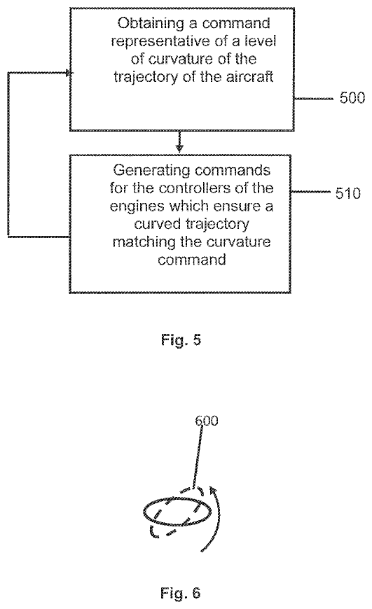

Attention is now drawn to FIG. 5.

When the aircraft is on the ground (in “taxi” mode), it is sometimes necessary to make the aircraft follow a non-linear trajectory, such as a curved or bent trajectory.

In some embodiments, the lever 110 controllable by the pilot comprises an interface allowing the pilot to provide a command representative of a level of curvature of the trajectory which is desired by the pilot for the aircraft.

According to some embodiments, this interface corresponds to a rotating member of the lever 110 (as explained e.g. with reference to FIG. 1B above—see rotating member 190). According to other embodiments, this interface can be a digital interface, such as a screen allowing the pilot to provide a command pertaining to the level of curvature of the trajectory of the aircraft.

According to some embodiments, the interface can communicate data with the common controlling unit 130 but is not necessarily physically located on lever 110, and can be located in another place in the cockpit.

When the pilot rotates this rotating member (or uses another interface allowing inputting a command representative of the curvature of the trajectory of the aircraft), the lever 110 or the interface itself can generate a command (hereinafter “curvature command”) correlated to the level of rotation, and which represents the level of curvature of the trajectory of the aircraft which is desired by the pilot.

The method can comprise obtaining (operation 500), by the common controlling unit 130, the curvature command. In some embodiments, this curvature command can be provided by the auto-pilot of the aircraft.

In some embodiments, a single interface (e.g. single rotating member) is present and provides a single curvature command. Based on this single curvature command, the system is able to provide a plurality of thrust commands adapted for each controller of each engine for matching this curvature command.

The method can comprise (operation 510) generating, based on this curvature command, at least one first command usable by a controller of at least one right engine for controlling thrust of the right engine based at least on this first command, and at least one second command usable by a controller of at least one left engine for controlling thrust of the left engine based at least on this second command.

In particular, first command and second command can be selected to obtain thrust of the right engine and thrust of the left engine which cause the aircraft to follow a curved trajectory which matches the curvature command of the pilot (e.g. according to some matching criteria which indicates that the difference is below a predetermined threshold).

For example, assume the pilot has rotated the rotating member as shown in position 600 of FIG. 6. This indicates that the aircraft has to bend its trajectory from right to left. As a consequence, the common controlling unit 130 can generate thrust commands for the controllers of the engines of the aircraft which induce an asymmetric propulsion, thereby ensuring that the aircraft will follow the bent trajectory.

For example, the common controlling unit 130 can generate a first thrust command for a controller of a right engine, and a second thrust command for a controller of a left engine, wherein the second thrust command is higher than the first thrust command, thereby making the aircraft bend its trajectory as desired by the pilot.

In particular, the difference between the first thrust command and the second thrust command can be determined in order to reflect the level of curvature required by the pilot (which depends e.g. on the level of rotation of the rotating member, or more generally on the curvature command).

If the pilot inputs a curvature command which corresponds to a straight trajectory (no curvature), then the common controlling unit 130 can transfer the thrust command of the lever 110 to each of the controllers of the engines so that their thrust will match the thrust command.

In some embodiments, assume the right engine and the left engine currently operate at the same thrust X, which is equal to the thrust command inputted by the pilot through lever 110. Assume a curvature command is provided by the pilot in order to make the aircraft bend its trajectory.

The method can comprise making the thrust of the right and left engines vary around power X, in order to match the curvature command. For example, assume the curvature command indicates a left turn. Thrust of the right engine can be increased to X+ε and/or thrust of the left engine can be decreased to X−ε, wherein ε is calibrated to comply with the curvature command.

According to some embodiments, if one engine has been detected as faulty (see above various embodiments for detecting this faulty state), the common controlling unit 130 can take into account this information in order to compute the thrust required for the other engines to produce the desired curved trajectory.

For example, assume the pilot inputted a command to bend left, and that one of the right engines is faulty.

If the right engine was not faulty, it would be enough to maintain thrust of all left engines to X and to set thrust of all right engines to X+ε. However, since one of the right engines is faulty, this can be insufficient to obtain the desired curvature. Therefore, the common controlling unit 130 can generate a command so that thrust of all right engines is set to X+α, with α>>ε, in order to comply with the curvature command while a right engine is faulty.

This example is not limitative and other tuning of the thrust of the engines can be performed to match the level of curvature desired by the pilot.

This also applies to cases wherein the pilot inputs a command to follow a straight trajectory (no curvature) and one engine is detected as faulty. According to some embodiments, the common controlling unit 130 transmits a thrust command to each of the controllers of the non-faulty engines in order to compensate for the fact that at least one engine is faulty. For example, assume thrust command of the lever is X, that one right engine is faulty, and that the pilot desires a straight trajectory. According to some examples, thrust of left engines can be maintained to X, but thrust of the non-faulty remaining right engines can be increased to X+ε, in order to compensate for the presence of at least one faulty right engine.

In some embodiments, the lever 110 can provide both:
a command representative of the level of curvature desired by the pilot (e.g. inputted by the pilot using a rotating member), and
a command representative of the thrust desired by the pilot for the engines (e.g. inputted by the pilot using the lever), or sent by the auto-throttle.

In this case, the commands generated by the common controlling unit 130 for the controllers of the engines can be tuned to reflect, as much as possible, both the command representative of the level of curvature desired by the pilot and the command representative of the thrust desired by the pilot or the auto-throttle for the engines.

For example, assume the pilot inputs a thrust command of X, which is transmitted by the common controlling unit 130 to the non-faulty engines.

Assume that the pilot also inputs a command reflecting a given level of curvature for the trajectory of the aircraft, then the common controlling unit 130 can create an asymmetric power of the engines around thrust command X (e.g. X+ε for at least some of the engines in order to match the desired level of curvature), thereby reflecting both the thrust command and the command pertaining to the curvature of the trajectory of the aircraft.

In some embodiments, the common controlling unit 130 can provide a thrust command which corresponds to a negative forward thrust, for one or more engines of the aircraft (in this case, E can be selected such as that X+ε is negative).

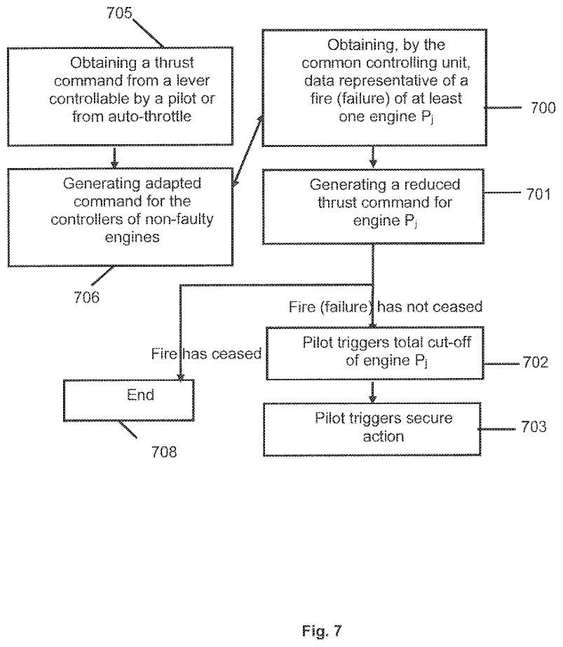

Attention is now drawn to FIG. 7, which describes another embodiment of a method of controlling engines of the aircraft. The method of FIG. 7 can be implemented using e.g. the system of FIG. 1 and the additional interface 180.

Operations depicted in FIG. 7 are not necessarily performed in the order in which they are depicted. In addition, at least some of operations depicted in FIG. 7 can be performed in parallel.

Assume the aircraft comprises engines P₁ to P_{N}, with N≥2.

The method can comprise obtaining (operation 700), by the common controlling unit 130, data representative of a fire of at least one engine Pⱼ. Although the method is described with respect to the presence of a fire, the method can be applied similarly to other failures that request a security action to be taken. Examples of failure include low oil pressure, presence of significant vibrations, etc.

This data can be sent e.g. by at least one controller of the engine Pⱼ, or by at least one sensor of the aircraft, or by at least one sensor operatively connected with the engine, or by a central processing unit of the aircraft, or by any other adapted system.

According to some embodiments, the common controlling unit 130 can instruct (operation 701) a controller of the faulty engine Pⱼ to set the faulty engine Pⱼ in an “IDLE” state, in which the thrust is reduced, but in which the engine Pⱼ is not yet totally turned off. This can be performed automatically, without intervention of the pilot.

Since the common controlling unit 130 independently sends an appropriate command to the correct controller controlling this specific engine under fire, error by the pilot is avoided (such as deactivation by the pilot of an operational engine, instead of a faulty engine).

The common controlling unit 130 can monitor the failure (e.g. fire) present in the engine, and, if after a predetermined duration, the failure is still present, it can trigger an alarm to the pilot. According to some embodiments, a visual alarm and/or an audio alarm can be triggered. According to some embodiments, triggering of the alarm is not performed by the common controlling unit 130, and can be performed by another system of the aircraft. At this stage, the fire is still being monitored and has not yet been handled.

If the fire has ceased after the predetermined duration, the method can end (operation 708). The fact that the fire has ceased can be known e.g. by receiving new data from the system which detected the fire (this new data can be received e.g. by the common controlling unit 130), which indicates that the fire has ceased, or in some cases, by a visual inspection of the team crew.

If the fire has not ceased after the predetermined duration, the pilot can activate (operation 702) the “fire” (or more generally “emergency”) position 184 of the interface 180, which cuts off additional elements of the engine Pⱼ or in communication with the engine Pⱼ (such as fuel and hydraulic supply, etc.—this corresponds to an emergency shutdown). In some embodiments, the common controlling unit 130 can control that the pilot has deactivated the correct engine Pⱼ, and if the pilot deactivates another engine, the common controlling unit 130 can ignore this command, to avoid an error. A corresponding alarm can be raised for the pilot.

In some embodiments, the common controlling unit 130 can activate by itself the “fire” (or more generally “emergency”) position 184.

In addition, the pilot can activate the discharge position 185 of the interface 180 for triggering a security action.

As a consequence of activation of the discharge position 185 of the interface 180, a security action can be triggered for handling the fire. For example, a firefighting agent (e.g. a powder) can be thrown from a firefighting device located in the vicinity of the engine, in order to extinguish the fire.

In some embodiments, the common controlling unit 130 can control that the pilot has ordered a security action for the correct engine Pⱼ, and if the pilot has ordered this security action for another engine, the common controlling unit 130 can ignore this command, to avoid an error. A corresponding alarm can be raised for the pilot.

As shown in FIG. 7, according to some embodiments, the system can receive thrust commands from the pilot (operation 705) while attempting to perform operations to handle a fire (or another failure) in at least one engine of the aircraft.

For example, even if an alarm pertaining to a fire has been received by the common controlling unit 130, the pilot can still provide thrust commands using the lever 110 (the same applies to the auto-throttle).

The common controlling unit 130 can convert this command into commands which are adapted for each controller of each engine, as explained in the various embodiments above (operation 706).

In particular, the common controlling unit 130 can generate thrust commands which comply with the pilot input or the auto-throttle input for the non-faulty engines, and can generate a command which reduces the thrust of the faulty engine as explained in operation 701.

According to some embodiments, if the aircraft is on the ground, and data representative of a fire has been received for a given engine, the system can behave, with respect to commands pertaining to the curved trajectory of the aircraft on the ground, as explained in the embodiment described with reference to FIG. 5 when one engine is faulty (that is to say that the common controlling unit 130 will take into account that one engine is faulty and will generate appropriate thrust commands for the non-faulty engines so that the total thrust allows the aircraft to follow the desired non-linear trajectory).

It is to be noted that the various features described in the various embodiments may be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1-26. (canceled)

27. A system for controlling a plurality of engines of an aircraft, wherein said plurality of engines includes at least one first engine of the aircraft and at least one second engine of the aircraft, the system comprising:
a common controlling unit configured to convert data representative of a thrust command transmitted by at least:
(i) a single actuating element operative to control thrust of all engines of the aircraft, said actuating element being controllable by a pilot; or
(ii) at least one of a single actuating element operative to control positive thrust of all of the plurality of engines of the aircraft, said single actuating element being controllable by a pilot, and a single actuating element operative to control negative thrust of all engines of the aircraft, said single actuating element being controllable by a pilot,
into:
(a) at least one first command usable by a controller of said at least one first engine for controlling operation of said at least one first engine based at least on said first command; and
(b) at least one second command usable by a controller of said at least one second engine for controlling operation of said at least one left engine based at least on said second command,
wherein said common controlling unit is operable to perform said conversion based at least on data representative of a level of operability of each engine determined during operation of the aircraft, thereby making each of the plurality of engines to either comply with said thrust command or to operate differently from said thrust command, based at least on a level of operability thereof during operation of the aircraft.

28. The system of claim 27, wherein the data representative of a thrust command is transmitted by an auto-throttle of the aircraft.

29. The system of claim 27, wherein at least one of (i) or (ii) is met by:
(i) the data representative of a thrust command includes a single thrust command for all engines of the aircraft;
(ii) said first command and said second command each substantially match said thrust command.

30. The system of claim 27, wherein the plurality of engines includes engines P₁ to P_{N}, with N≥2, wherein, when the common controlling unit receives data representative of a failure of at least one engine Pⱼ of said plurality of engines, the common controlling unit is configured to:
generate a command usable by at least one controller, for controlling thrust of engines Pᵢ, with i from 1 to N being different from j, wherein said thrust is controlled in accordance with said data representative of a thrust command received by said common controlling unit.

31. The system of claim 27, wherein the plurality of engines includes engines P₁ to P_{N}, with N≥2, wherein when the system receives data representative of a failure of at least one engine Pⱼ of said plurality of engines, the common controlling unit is configured to:
instruct, by the common controlling unit, a controller of said engine Pⱼ to reduce thrust of engine Pⱼ at a first thrust value, wherein said first thrust value is lower than said thrust command.

32. The system of claim 31, configured to generate a command for controlling position of a yaw actuator of the aircraft, to compensate a yaw drift caused by said failure.

33. The system of claim 27, wherein the plurality of engines includes engines P₁ to P_{N}, with N≥2, wherein the common controlling unit is configured to, upon receipt of a command instructing to turn on engine Pⱼ:
instruct a controller of said engine Pⱼ to increase thrust of engine Pⱼ at a first thrust value, wherein said first thrust value differs from the thrust command; and
after a stabilization period, instruct said controller of said engine Pⱼ to set thrust of engine Pⱼ at a second thrust value which substantially matches said thrust command.

34. The system of claim 27, further comprising, for each of the plurality of engines, an interface including:
a security action position, which, upon activation, is configured to trigger a security action for handling a failure present in said engine;
a start position, which, upon activation, is configured to start said engine; and
a cut or emergency position, which, upon activation, turns off said engine, partially or totally.

35. The system of claim 27, further comprising an interface allowing inputting a command representative of a curvature of a trajectory of the aircraft on the ground.

36. The system of claim 35, wherein, upon input of a command through said interface, the common controlling unit is configured to generate:
at least one first command usable by a controller of at least one right engine for controlling thrust of said at least one right engine in compliance with said at least one first command; and
at least one thrust command usable by a controller of at least one left engine for controlling thrust of said at least one left engine in compliance with said at least one second command;
wherein thrust of said at least one right engine and thrust of said at least one left engine are selected to make the aircraft follow a curved trajectory which complies with said curvature.

37. A system for controlling a plurality of engines of an aircraft, wherein said plurality of engines includes at least one right engine and at least one left engine, the system comprising:
an interface operable by a pilot to provide a single curvature command representative of a curvature of a trajectory of the aircraft on the ground,
a common controlling unit configured to:
generate at least one first command usable by at least one controller of said at least one right engine for controlling thrust of said at least one right engine based at least on said first command; and
generate at least one second command usable by at least one controller of said at least one left engine for controlling thrust of said at least one left engine based at least on said at least one second command;
wherein said first command and said second command are selected such that thrust of said at least one right engine and thrust of said at least one left engine allow the aircraft to follow a curved trajectory representative of said single curvature command provided on said interface.

38. A method of controlling a plurality of engines of an aircraft, wherein said plurality of engines includes at least one first engine of the aircraft and at least one second engine of the aircraft, the method comprising:
obtaining data representative of a thrust command for said plurality of engines, transmitted by at least:
(i) a single actuating element operative to control thrust of all engines of the aircraft, said actuating element being controllable by a pilot; or
(ii) at least one of a single actuating element operative to control positive thrust of all engines of the aircraft, said actuating element being controllable by a pilot, and a single actuating element operative to control negative thrust of all engines of the aircraft, said actuating element being controllable by a pilot; and
converting, by a common controlling unit, said data representative of said thrust command into:
at least one first command usable by a controller of said at least one first engine for controlling operation of said at least one first engine based at least on said first command; and
at least one second command usable by a controller of said at least one second engine for controlling operation of said at least one second engine based at least on said second command,
wherein said conversion is performed based at least on data representative of a level of operability of each engine determined during operation of the aircraft, thereby making each engine to either comply with said thrust command or to operate differently from said thrust command, based at least on its level of operability during operation of the aircraft.

39. The method of claim 38, wherein at least one of (i), (ii), or (iii) is met by:
(i) the data representative of a thrust command is transmitted by an auto-throttle of the aircraft;
(ii) the data representative of a thrust command includes a single thrust command for all engines of the aircraft;
(iii) said first command and said second command each substantially match said thrust command.

40. The method of claim 38, wherein the plurality of engines includes engines P₁ to P_{N}, with N≥2, the method further comprising:
receiving data representative of a failure at least one engine Pⱼ of said plurality of engines; and
generating a command usable by at least one controller, for controlling thrust of engines Pᵢ, with i from 1 to N being different from j, wherein said thrust is controlled in accordance with said data representative of a thrust command received by said common controlling unit.

41. The method of claim 38, wherein the plurality of engines includes engines P₁ to P_{N}, with N≥2, the method further comprising:
receiving data representative of a failure of at least one engine Pⱼ of said plurality of engines; and
instructing, by the common controlling unit, a controller of said engine Pⱼ to reduce thrust of engine Pⱼ at a first thrust value, wherein said first thrust value is lower than said thrust command.

42. The method of claim 38, wherein the plurality of engines includes engines P₁ to P_{N}, with N≥2, the method comprising, upon receipt of a command instructing to turn on engine Pⱼ:
instructing a controller of said engine Pⱼ to increase thrust of engine Pⱼ at a first thrust value, wherein said first thrust value differs from the thrust command; and
after a stabilization period, instructing said controller of said engine Pⱼ to set thrust of engine Pⱼ at a second thrust value which substantially matches said thrust command.

43. The method of claim 38, further comprising receiving from an interface controllable by the pilot a command representative of a curvature of a trajectory of the aircraft on the ground, wherein, upon input of a command through said interface, the method comprises generating:
at least one first command usable by a controller of at least one right engine for controlling thrust of said at least one right engine in compliance with said at least one first command; and
at least one thrust command usable by a controller of at least one left engine for controlling thrust of said at least one left engine in compliance with said at least one second command;
wherein thrust of said at least one right engine and thrust of said at least one left engine are selected to make the aircraft follow a curved trajectory which complies with said curvature.

44. A method of controlling a plurality of engines of an aircraft, wherein said plurality of engines includes at least one right engine and at least one left engine, the method comprising:
obtaining a single curvature command representative of a curvature of a trajectory of the aircraft on the ground; and
based on said command, generating, by a common controlling unit,
at least one first command usable by at least one controller of said at least one right engine for controlling thrust of said at least one right engine based at least on said at least one first command; and
at least one second command usable by at least one controller of said at least one left engine for controlling thrust of said at least one left engine based at least on said at least one second command,
wherein said at least first command and said at least one second command are selected such that thrust of said at least one right engine and thrust of said at least one left engine allow the aircraft to follow a curved trajectory representative of said single curvature command.
